(19) United States
(12) Patent Application Publication
(10) Pub. No.: US 2006/0232978 A1
(43) Pub. Date: Oct. 19, 2006

(54) Compact reflector lamp and method for its production

(75) Inventor: Richard Lang, Kinding (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/405,551

(22) Filed: Apr. 18, 2006

(30) Foreign Application Priority Data
Apr. 19, 2005 (DE) 10 2005 018 115.5

(51) Int. Cl. F21V 7/00

(52) U.S. Cl. 362/341

(57) ABSTRACT

A compact reflector lamp (1) has a reflector (3) which is formed from a reflective substrate material which closely surrounds a lamp vessel section and the lamp neck (6) and in the process is supported on the lamp stem (7).

### TECHNICAL FIELD

The invention is based on a reflector lamp, i.e. a lamp in the case of which the emitted light is deflected into a desired solid angle range with the aid of a reflector.

Light generation itself can in this case take place by means of incandescent filaments (incandescent reflector lamp) or by means of a gas discharge (reflector discharge lamp).

Such lamps are used increasingly in general lighting and special-effect lighting, but also for photo-optical purposes.

### BACKGROUND ART

The specification EP 0 495 194 B1 has disclosed a reflector lamp, in which a low-volt halogen incandescent lamp has been cemented into a cold-light reflector. The cold-light reflector comprises a mirror-coated spherical glass cap. Such reflector lamps are not compact because the reflector is relatively large, in any case considerably larger than the halogen incandescent lamp itself, which is arranged in the optical axis of the reflector. In recent times, however, the trend has increasingly been for very compact light sources which also provide more leeway for the design of the luminaire. In addition, manufacture is relatively complex because the spherical glass cap needs to be provided with the mirror coating after forming, and then the halogen incandescent lamp needs to be cemented into the complete reflector.

The specification CA 2 522 494 A1 has disclosed a compact reflector lamp, in the case of which a lamp vessel section of a low-volt halogen incandescent lamp is provided with a light-reflective coating. This may be a metallic or dichroitic coating. The first exemplary embodiment shows an axial reflector, in the case of which the light is preferably emitted in the direction of the longitudinal axis of the lamp. The second exemplary embodiment shows a side reflector, in the case of which the light is preferably emitted laterally, i.e. in a direction perpendicular to the longitudinal axis of the lamp. One disadvantage is the fact that a coating process which is technically relatively complex, for example vapor deposition or sputtering, is required for coating the lamp. For this purpose, the otherwise complete lamp needs to be removed from the lamp production line and brought into a mirror-coating reactor. In addition, the coating process is relatively costly compared to the remaining production costs of the lamp.

### DISCLOSURE OF THE INVENTION

The object of the present invention is to provide a compact reflector lamp which can be produced in a technically simpler manner. One further aspect is for it to be possible for it to be produced in a manner which is as cost-effective as possible.

This object is achieved by a compact reflector lamp having a lamp stem, from which outer power supply lines are passed, and a lamp vessel, which has a lamp vessel section which is closely surrounded by a reflective substrate material in the form of a reflector.

In addition, protection is claimed for a method for producing the reflector lamp according to the invention.

According to the invention, a reflective substrate material is used as the reflector instead of a coating. The term “closely surrounded” is also to be understood in this context. That is to say, in a similar manner to a coating, the reflector conforms closely to the contour of the lamp vessel such that the lamp according to the invention is very compact despite the reflector. For this purpose, a mirror-coated sheet or metal sheet or a mirror-coated film, preferably made from aluminum, which is particularly suitable for this purpose, is used as the reflective substrate material, for example. The reflective properties of the substrate material can advantageously be improved by a reflection-enhancing layer composite. Details in this regard are found in, for example, U.S. Pat. No. 5,760,981 A.

It is thus possible to dispense with the technically complex coating process during lamp manufacture. Instead, a previously mirror-coated substrate material is integrally formed on a lamp vessel section in the production line. In order to increase the reliability and durability of the fixing of the previously mirror-coated substrate material, it may be advantageous to also join the integrally formed substrate material, for example to weld it. In any case, no additional parts or auxiliary materials, such as cement, are required for the purpose of fixing the previously mirror-coated substrate material.

In one preferred embodiment, the reflector lamp has a lamp neck in the form of a constriction between the lamp vessel and the lamp stem. The reflective substrate material surrounds this lamp neck relatively closely and in the process can be supported on the lamp stem. In this manner, the reflective substrate material in the form of a reflector is secured against sliding in the direction of the lamp longitudinal axis.

One first variant relates to a reflector lamp having an axial reflector. In this case, the reflective substrate material surrounds the lamp vessel in a similar manner to a funnel. In its simplest refinement, the lamp vessel may be spherical or cylindrical. As long as the reflective substrate material closely surrounds the lamp neck, sliding in the axial direction is in any case prevented relatively well. However, in this variant it is preferable for the lamp vessel section surrounded by the reflective substrate material to taper in the direction towards the lamp neck. At the end opposite the lamp stem, the lamp vessel typically has a bowl, through which light is emitted during operation of the lamp.

A second variant relates to a reflector lamp having a side reflector. In this case, the lamp vessel section surrounded by the reflective substrate material corresponds at least approximately to one half of the length of the lamp vessel. The shape of the lamp vessel in this case likewise only plays a subordinate role. In this variant, it may be flat, in particular in the direction of the lateral emitted light, i.e. not necessarily rotationally symmetrical about the longitudinal axis of the lamp. The reflective substrate material typically has the shape of a hood, the neck part of the hood being supported on the stem part of the lamp and being used for fixing purposes.

Overall, with the reflector lamp according to the invention, the specific type of light generation at best plays a subordinate role. In particular, the lamp may be an incandescent lamp or else a discharge lamp.

In any case, when the reflector lamp according to the invention is produced, initially a lamp having a lamp vessel including a lamp stem is provided, then the reflective substrate material is cut to an appropriate size and finally the reflective substrate material, which has been cut to size, is integrally formed on the lamp vessel section provided for this purpose. After this integral forming, the two abutting edges of the reflective substrate material are joined, for example by means of welding, by being bent back or being pushed through. Then, the reflective substrate material is reliably fixed to the lamp vessel. Alternatively, the substrate material can also be formed from two flap halves which are connected at their two joints once they have been integrally formed on the lamp vessel.

### BRIEF DESCRIPTION OF THE DRAWINGS

The invention will be explained in more detail below with reference to exemplary embodiments. In the drawings:

FIG. 1a shows a reflector lamp according to the invention of the axial reflector type,

FIG. 1b shows a detailed illustration of the lamp shown in FIG. 1a,

FIG. 2a shows a reflector lamp according to the invention of the side reflector type, in an illustration from the side, and

FIG. 2b shows a front view, rotated through 90°, of the lamp shown in FIG. 2a.

### BEST MODE FOR CARRYING OUT THE INVENTION

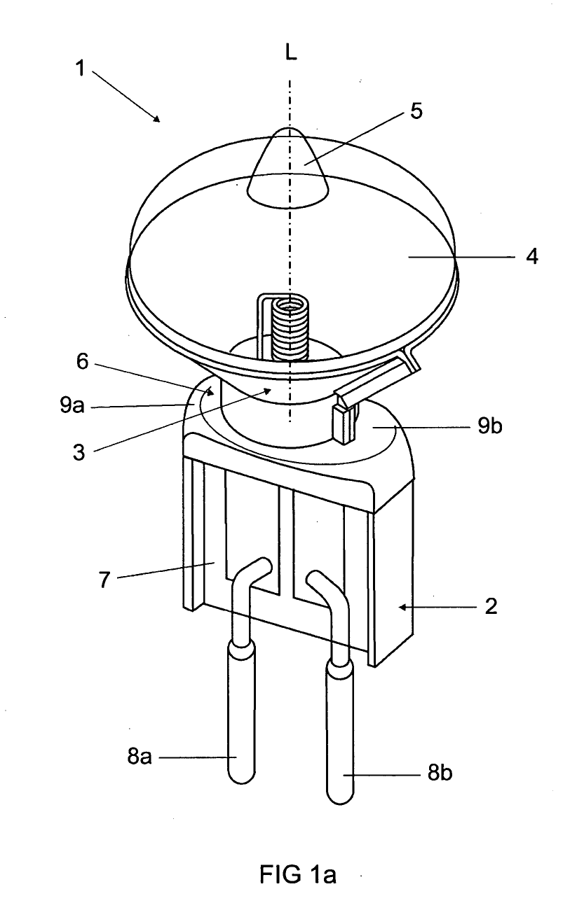

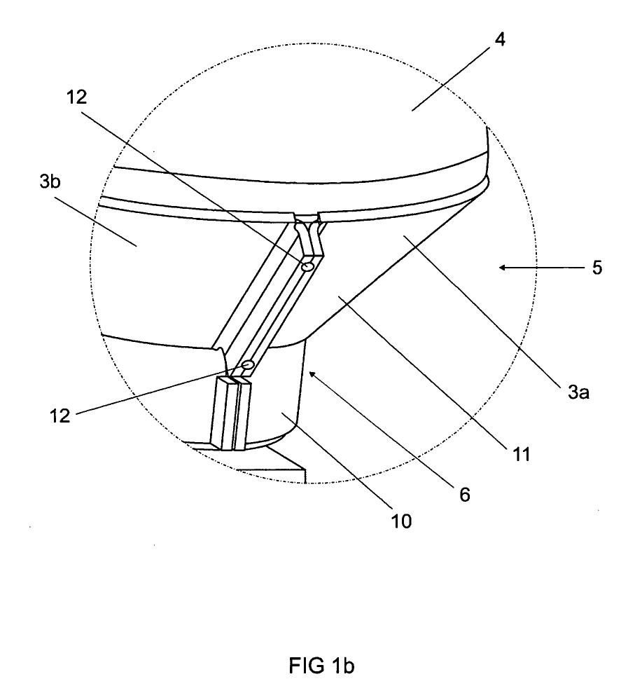

FIGS. 1a and 1b show a reflector lamp 1 according to the invention in an overall view and in a detailed view, respectively. In this case, the lamp is a low-volt halogen incandescent lamp having a plug-in base 2 of the GY type and an axial reflector 3. At its end opposite the plug-in base 2, the reflector lamp 1 has a dome-like bowl 4 having a tip 5. The bowl 4 with the tip 5 closes the vessel, remote from the base, of the reflector lamp 1 and is used during operation as the light exit surface. The bowl 4 merges with a conical vessel section 5, which opens out into a cylindrical lamp neck 6. The GY plug-in base 2, which comprises an essentially parallelepipedal lamp stem 7 and two power supply pins 8a, 8b, which protrude at the end of said lamp stem 7 in the longitudinal direction L of the reflector lamp 1, adjoins the lamp neck 6. The two power supply pins 8a, 8b are connected to an incandescent filament (not illustrated) which is arranged in the interior of the lamp vessel via two inner power supply lines (not illustrated) which are pinched into the lamp stem 7 in a gas-tight manner. The lamp stem 7 is markedly wider than the relatively narrow lamp neck 5, by means of which two shoulder-like lamp stem sections 9a, 9b are formed. The axial reflector 3, which comprises a previously mirror-coated substrate material made from sheet aluminum (for example MIRO® by Alanod), is supported on these shoulder-like lamp stem sections 9a, 9b. The axial reflector 3 comprising two half-shells 3a, 3b has a cylindrical collar 10, which closely surrounds the lamp neck 5, and a conical section 11, which closely surrounds the conical vessel section 5 of the lamp. For this purpose, the two half-shells 3a, 3b are formed by means of deep-drawing and then cut out from a sheet-metal strip of the previously mirror-coated substrate material, which is initially also provided with a protective film for the purpose of protecting the mirror-coated surface from damage. Then, the two half-shells are integrally formed on the halogen incandescent lamp and are connected to one another with in each case two laser weld spots 12 per abutting edge (the rear abutting edge cannot be seen in FIGS. 1a and 1b) . For this purpose, the abutting edges are bent perpendicularly outwards in one end section such that they lie directly next to one another in the manner of a flange instead of abutting one another. Alternatively, however, the edges can also be butt-welded. In principle, the reflector collar and the conical reflector section can also be of two-part design. In any case, the light is emitted exclusively via the dome-like bowl 4, i.e. in the axial direction.

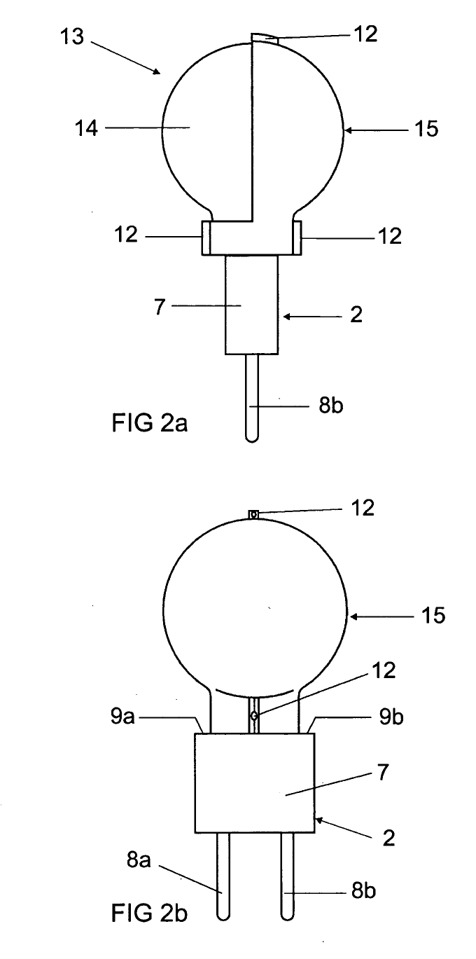

FIGS. 2a and 2b show a side view and a front view, rotated through 90° with respect to the side view, of a second exemplary embodiment 13 of a reflector lamp according to the invention. In this case, the lamp is likewise a low-volt halogen incandescent lamp having a plug-in base 2 of the GY type, but having an essentially spherical lamp vessel and side reflector 15. Otherwise, further identical features are provided with the same reference numerals. The side reflector 15 is in the form of a hood and is divided into two identical parts, which are connected to one another by means of laser weld spots at bent-back abutting edge sections in the region of the reflector collar and of the hood apex. As a result, a lamp vessel section, which corresponds to half of the length of the essentially spherical lamp vessel, is surrounded by the reflective substrate material of the side reflector 15. Light is emitted from this reflector lamp 13 essentially laterally through the uncovered vessel section.

Although the invention has been explained in more detail above using the example of a halogen incandescent lamp, it is not restricted to this lamp type. Rather, it also has an advantageous effect with other types of lamp, in particular also with discharge lamps.

1. A compact reflector lamp having a lamp stem, from which outer power supply lines are passed, and a lamp vessel which has a lamp vessel section which is closely surrounded by a reflective substrate material in the form of a reflector.

2. The reflector lamp as claimed in claim 1, the reflective substrate material being a mirror-coated sheet or metal sheet or a mirror-coated film.

3. The reflector lamp as claimed in claim 2, the substrate material being made from aluminum.

4. The reflector lamp as claimed in claim 1, which has a lamp neck in the form of a constriction between the lamp vessel and the lamp stem, the reflective substrate material closely surrounding this lamp neck and in the process being supported on the lamp stem.

5. The reflector lamp as claimed in claim 1, the lamp vessel section surrounded by the reflective substrate material tapering in the direction towards the lamp neck, and, at the end opposite the lamp stem, the lamp vessel having a bowl, through which light is emitted during operation of the lamp.

6. The reflector lamp as claimed in claim 1, the lamp vessel section surrounded by the reflective substrate material corresponding to one half of the length of the lamp vessel.

7. The reflector lamp as claimed in claim 1 in the form of an incandescent lamp.

8. The reflector lamp as claimed in claim 1 in the form of a discharge lamp.

9. A method for producing a reflector lamp having the features as claimed in claim 1, having the following method steps:
provision of the lamp vessel including the lamp stem,
provision of a previously mirror-coated material as the reflective substrate material,
cutting the reflective substrate material to size,
integrally forming the reflective substrate material on the lamp vessel section provided for this purpose.

10. The method as claimed in claim 9, in which, once the reflective substrate material has been integrally formed, the two abutting edges of said substrate material are joined, for example by means of welding, by being bent back or being pushed through.

11. The method as claimed in claim 9, in which two flap halves are formed from the substrate material which are connected to one another at their seam once they have been integrally formed on the lamp vessel.

12. The reflector lamp as claimed in claim 2, which has a lamp neck in the form of a constriction between the lamp vessel and the lamp stem, the reflective substrate material closely surrounding this lamp neck and in the process being supported on the lamp stem.

13. The reflector lamp as claimed in claim 3, which has a lamp neck in the form of a constriction between the lamp vessel and the lamp stem, the reflective substrate material closely surrounding this lamp neck and in the process being supported on the lamp stem.
